(19) United States
(12) Patent Application Publication
(10) Pub. No.: US 2006/0009519 A1
(43) Pub. Date: Jan. 12, 2006

(54) Antifeeding method against insects

(75) Inventors: Noritada Matsuo, Amagasaki-shi (JP); Shun-ichi Kubota, Toyonaka-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 11/174,528

(22) Filed: Jul. 6, 2005

(30) Foreign Application Priority Data
Jul. 8, 2004 (JP) 2004-201575

(51) Int. Cl. A01N 37/10

(52) U.S. Cl. 514/543

(57) ABSTRACT

Wooden material can be protected by applying a C8-C12 alkyl ester of gallic acid to the wooden material from feeding by insects.

### FIELD OF THE INVENTION

The present invention relates to protection of wooden material against insects. In particular, it relates to use of gallates for an antifeeding method against insects which are harmful to wooden material.

### BACKGROUND ARTS

It is known that some esters of gallic acid are effective for controlling wood-rotting fungi in JP2001-158008A.

### SUMMARY OF THE INVENTION

The present invention provides a use of a C8-C12 alkyl ester of gallic acid for preventing insects from feeding wooden material, namely a method for preventing insects from feeding wooden material, which comprises applying an effective amount of a C8-C12 alkyl ester of gallic acid to wooden material.

### DISCLOSURE OF THE INVENTION

In the present invention, the C8-C12 alkyl ester of gallic acid is given by the formula (I): 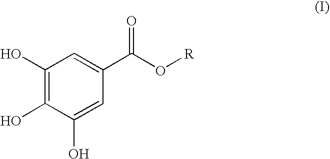
wherein R represents a C8-C12 alkyl group.
Hereinafter, the ester of gallic acid is referred to as “the gallate (I)”.

Preferred R is a straight chain C8-C12 alkyl group. Examples of the gallate (I) include octyl gallate, nonyl gallate, decyl gallate, undecyl gallate and dodecyl gallate.

The gallate (I) can be produced by conventional methods and typical procedure is given below.

The gallate (I) can be produced by the reaction of gallic acid with the alcohol compound of the formula (II) in the presence of an acid. 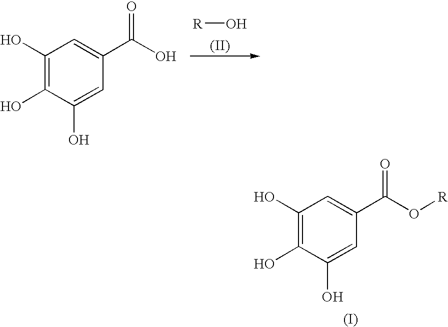
wherein R has the same meaning as given above.

The reaction is carried out in a solvent or without solvent. When the solvent is used, examples of the solvent include aliphatic hydrocarbons such as octane and nonane, aromatic hydrocarbons such as toluene and xylene, and mixtures thereof.

Examples of the acid for the reaction include organic acids such as p-toluenesulfonic acid and camphorsulfonic acid and inorganic acids such as sulfuric acid and hydrochloric acid. The amount of the acid used for the reaction is generally 0.01 to 1 mole per 1 mole of the gallic acid.

The amount of the alcohol compound of the formula (II) used for the reaction is generally 0.7 to 1.5 moles per 1 mole of the gallic acid.

The reaction temperature is generally within the range of from 20° C. to 200° C. or the boiling point of the solvent, and the reaction period is generally 0.1 to 72 hours. The reaction may be carried out optionally under removing the water produced during the reaction with molecular sieves or by water-separator.

After the reaction, the product can be isolated by conventional procedures such as extraction with an organic solvent, drying and concentration. The isolated product may be further purified by washing with an organic solvent, recrystallization, chromatography and so on.

The insect which is harmful to wooden material is typically termites (Isopteran insects), but it may include Coleopteran insects such as powderpost beetles (Lyctidae), false powderpost beetles (Bostrychidae), deathwatch beetles (Anobiidae), long-horned beetles (Cerambycidae) and so on.

Examples of the termites include Mastotermitidae; Termospsidae such as Zootermopsis spp. (e.g. Z. nevadensis), Archotermopsis spp., Hodotermopsis spp. (e.g. H japonica), Porotermes spp. and Stolotermes spp.; Kalotermitidae such as Kalotermes spp., Neotermes spp. (e.g. N. koshunensis), Cryptotermes spp. (C. domesticus), Incistermes spp. (e.g. I. minor) and Glyptotermes spp. (e.g. G. satsumensis, G. nakajimai, G. fuscus, G. kodamai, G. kushimensis); Hodotermitidae such as Hodotermes spp., Microhodotermes spp. and Anacanthotermes spp.; Rhinotermitidae such as Reticulitermes spp. (e.g. R. speratus, R. miyatakei, R. flaviceps amamianus, R. kanmonesis, R. flavipes, R. Hesperus, R. virginicus, R. tibialis), Heterotermes spp. (e.g. H. aureus), Coptotermes spp. (e.g. C. formosanus, C. guangzhoensis) and Schedolinotermes spp.; Serritermitidae; and Termitidae such as Amitermes spp., Drepanotermes spp., Hopitalitermes spp., Trinervitermes spp., Macrotermes spp., Odontotermes spp. (e.g. O. formosanus), Microtermes spp., Nasutitermes spp. (e.g. N. takasagoenesis), Pericapritermes spp. (e.g. P. nitobei), Anoplotermes spp. and Sinocapritermes spp. (e.g. S. mushae).

The wooden material prevented from feeding by the insects means the material made or consisting wholly or partly of wood as well as wood itself. The wooden material is not limited so long as it contains cellulose. Examples of the wooden material include wood; engineering wood such as plywood, particle board, fiber board, wafer board, laminated wood, strand board, LVL (laminated veneer lumber), OSL (oriented strand lumber), OSB (oriented strand board) and flake board; and paper.

The gallate (I) is applied to the wooden material for preventing the insects from feeding the wooden material. The wooden material may constitute building, wall, pillar, the interior and so on. The dosage of the gallate (I) is generally 0.01 to 100 g/m², preferably 0.1 to 10 g/m². When a liquid containing the gallate (I) as an active ingredient is applied, the application liquid usually contains 0.001 to 60% by weight of the gallate (I), preferably 0.01 to 20% by weight of the gallate (I). The application can be performed by surface-treating methods such as painting on the surface and spraying on the surface, penetrating methods such as dipping, soaking in warm or cool bath and injecting under increased or reduced pressure.

The gallate (I) can be applied as it is; however, a formulation containing the gallate (I) as an active ingredient is used in general. The formulation can include liquid carrier and/or solid carrier, optionally auxiliaries such as surfactant, dispersing agent, stabilizer, spreading agent, anti-foaming agent, anti-rust agent, anti-freezing agent, anti-corrosive agent, fungicide, penetration-assisting agent and so on. The content of the gallate (I) in the formulation is generally 0.01 to 80% by weight.

When the formulation is a liquid solution, it can be produced by mixing the gallate (I), a solvent and optionally anti-corrosive agent, UV-stabilizer, antioxidant, desiccant and coloring agent.

Examples of the anti-corrosive agent include benzoic acid, sodium benzoate, propyl p-hydroxybenzoate, butyl p-hydroxybenzoate, o-phenylphenol, sodium o-phenylphenolate, dehydroacetic acid, sodium dehydroacetate, thiabendazole and 3-iodo-2-propargyl butyl carbamate (IPBC). Examples of the antioxidant include dibutylhydroxytoluene (BHT), butylhydroxyanisole (BHA), erythorbic acid, ascorbic acid, tocopherol and stannous chloride. Examples of the desiccant include calcium oxide and silica gel. Examples of the coloring agent include inorganic pigments such as iron oxide, titanium oxide and Prussian blue and organic dyestuffs such as alizarin dyestuff, azo dyestuff, metal phthalocyanin dyestuff and salts thereof (e.g., iron salts, manganese salts, boron salts, copper salts, cobalt salts, molybdenum salts, zinc salts).

When the formulation is a flowable formulation such as suspension in water and emulsion in water, it can be produced by dispersing the gallate (I), a dispersing agent which is a material for providing protective colloid or thixotropic character, and optionally the other auxiliaries in water. By using an oil, which does not dissolve the gallate (I), in place of water, a suspension-in-oil formulation can be produced.

Microcapsule formulations can be produced by usual methods such as interfacial polymerization method, In-situ method, phase separation method, solvent evaporation method, spray-drying method, cooling after melting-dispersing method and pan-coating method.

Typical procedure of the interfacial polymerization method is explained in detail below: One to 50% by weight of the gallate (I) and 0.001 to 1% by weight of a water-insoluble monomer, which may be dissolved in a water-insoluble organic solvent in advance, are dispersed in the water containing 0.001 to 1% by weight of a water-soluble monomer. At that time, 0.001 to 5% by weight of a surfactant and/or water-soluble polymer can be added thereto. Microcapsules can be produced as a suspension by the reaction at 30 to 80° C. for 1 to 48 hours. To the obtained suspension containing the microcapsules, a dispersing agent, which is a material for providing protective colloid or thixotropic character, and the other auxiliaries such as stabilizer, spreading agent, anti-foaming agent, anti-rust agent, anti-freezing agent, anti-corrosive agent, fungicide, penetration-assisting agent and so on may be added. The wall materials of the microcapsules produced by the interfacial polymerization method are polyamide made from polyvalent acid halide as a water-insoluble monomer and polyamine as a water-soluble monomer, polyester made from polyvalent acid halide as a water-insoluble monomer and polyphenol as a water-soluble monomer, polyurethane made from polyisocyanate as a water-insoluble monomer and polyol as a water-soluble monomer and so on.

In the method of the present invention, an insecticidal compound, repellent compound or synergist can be applied to wooden material together with the gallate (I). The insecticidal compound, repellent compound and synergist may be mixed with the gallate (I) prior to the application. Therefore, the formulation may further contain one or more insecticidal compounds, repellent compounds and synergists.

Examples of the insecticidal compound include organophosphorus compounds such as fenitrothion, fenthion, diazinon, chlorpyrifos, DDVP, cyanophos, dimethoate, phenthoate, malathion and azinphos-methyl; carbamate compounds such as BPMC, benfuracarb, propoxyur and carbaryl; pyrethroid compounds such as etofenprox, fenvalerate, esfenvalerate, fenpropathrin, cypermethrin, permethrin, cyhalothrin, deltamethrin, cycloprothrin, fluvalinate, bifenthrin, halfenprox, tralomethrin, silafluofen, d-phenothrin, cyphenothrin, d-resmethrin, acrinathrin, cyfluthrin, tefluthrin, transfluthrin, tetramethrin, allethrin, prallethrin, empenthrin, imiprothrin and d-furamethrin; nitroimidazolidine compounds such as imidacloprid; N-cyanoamidine compounds such as acetamiprid; chloronicotinyl compounds such as nitenpyram, thiacloprid, clothianidin and dinotefuran; chlorinated hydrocarbon compounds such as endosulfan and γ-BHC; benzoylphenylurea compounds such as chlorfluazuron, teflubenzuron and flufenoxuron; thiourea compounds such as diafenthiuron; phenylpyrazole compounds; chlorfenapyr; metoxadiazone; bromopropylate; tetradifon; quinomethionate; pyridaben; fenpyroximate, tebufenpyrad; polynactins such as tetranactin, dinactin and trinactin; pyrimidifen; milbemectib; abamectin; ivermectin and azadiractin.

Examples of the repellent compound include 3,4-caranediol, N,N-diethyl-m-toluamide, 1-methylpropyl 2-(2-hydroxyethyl)-1-piperidinecarboxylate, p-menthane-3,8-diol, vegetable oils such as hyssop oil.

Examples of the synergist include bis(2,3,3,3-tetrachloropropyl) ether (S-421), N-(2-ethylhexyl)bicycle[2.2.1]hept-5-ene-2,3-dicarboximide (MGK-264) and α-[2-(2-butoxyethoxy)ethoxy]-4,5-methylenedioxy-2-propyltoluene (piperonyl butoxide).

In the method of the present invention, a wood preservative can be applied to wooden material together with the gallate (I). The wood preservative may be mixed with the gallate (I) prior to the application. Therefore, the formulation may further contain one or more preservatives such as cyproconazole, hexaconazole and tebuconazole.

### EXAMPLES

Hereinafter, the present invention is explained in more detail referring to examples, but the present invention should not be limited to the following examples.

At first, examples of the formulation containing the gallate (I) used for the method of the present invention are given below.

### Formulation Example 1

Two parts by weight of the gallate (I) are dissolved in 10 parts by weight of dichloromethane and mixed with 88 parts by weight of Isopar M (isoparaffin produced by Exxon Chemical) to give 2% oil solution.

### Formulation Example 2

One hundred grams (100 g) of the gallate (I), 4.8 g of Sumidule L-75 (aromatic polyisocyanate produced by Sumika-Bayer Urethane) and 100 g of Solvesso 200 (aromatic solvent produced by Exxon Chemical) are mixed uniformly, the mixture is added to 175 g of 10% by weight of gum arabic of aqueous solution containing 6 g of ethylene glycol and dispersed under stirring with T.K. Autohomomixer (produced by Tokushugikakogyo) at room temperature at 3500 rpm to give fine droplets. Further, gentle stirring at 60° C. for 24 hours gives a microcapsule slurry in which the gallate (I) was encapsulated with polyurethane wall. To the obtained slurry, 614.2 g of aqueous solution containing 2 g of xanthan gum and 4 g of aluminum silicate are added to give a microcapsule formulation containing 10% by weight of the gallate (I).

### Formulation Example 3

A mixture obtained by mixing uniformly 20.95 g of the gallate (I), 4 g of Soprophor FLK (potassium polyoxyethylene tristyryl phenyl ether phosphate produced by Rhodia), 5 g of propylene glycol, 0.1 g of Antifoam C (silicone type antifoaming agent produced by Dow Corning) and 48.85 g of ion-exchanged water is pulverized with glass beads having 1.0 to 1.5 mm of diameter to give a pulverized slurry. To the slurry, 20 g of aqueous solution containing 0.1 g of Antifoam C, 0.2 g of xanthan gum and 0.5 g of aluminum magnesium silicate are added and mixed uniformly to give a flowable formulation containing 10% by weight of the gallate (I).

The gallate (I) can be prepared by the following example.

### Preparation Example

A mixture of 1.0 g of gallic acid, 0.84 g of decyl alcohol and 0.1 g of p-toluenesulfonic acid was stirred under heating at 150° C. for 2 hours while removing water. After allowing the reaction mixture to stand cool to room temperature, it was poured into 20 ml of saturated aqueous sodium bicarbonate solution and extracted with 70 ml of ethyl acetate. The organic layer was washed with saturated brine, dried over anhydrous sodium sulfate and evaporated under reduced pressure. The obtained residue was subjected to silica gel chromatography to give 1.4 g of decyl gallate.

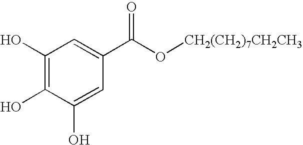

¹H-NMR (DMSO-d₆)

δ (ppm): 0.85 (3H, t), 1.25 (14H, br), 1.63 (2H, t), 4.14 (2H, t), 6.93 (2H, s) Octyl gallate was prepared from gallic acid and octyl alcohol by the similar manner mentioned above.

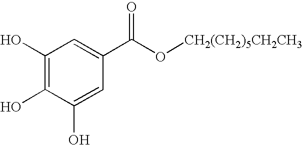

¹H-NMR (DMSO-d₆)

δ (ppm): 0.83 (3H, t), 1.24 (10H, br), 1.63 (2H, t), 4.13 (2H, t), 6.94 (2H, s) Dodecyl gallate was prepared from gallic acid and dodecyl alcohol by the similar manner mentioned above.

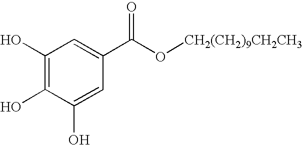

¹H-NMR (DMSO-d₆)

δ (ppm): 0.85 (3H, t), 1.22 (18H), 1.64 (2H, t), 4.15 (2H, t), 6.97 (2H, s)

Next, the method of the present invention is explained by examples.

### Test Example 1

A designated amount (10 mg or 100 mg) of octyl gallate was dissolved in 0.3 ml of acetone and uniformly spread on a piece of Japanese black pine wood (1 cm×1 cm×2 cm) with pipette. The wood was allowed to stand overnight at room temperature, dried at 60° C. in a thermostat for 3 days, and then the weight of the wood was measured.

The bottom of a 200 ml-volume plastic cup having several holes on the bottom was covered with gypsum in 2 cm thickness. The wood prepared above and 100 termites (Coptotermes formosanus, workers) were put in the plastic cup and kept in the dark for 3 weeks. For that time, cotton wool containing water was set under the plastic cup, and the gypsum was kept wet through the hole. After 3 weeks, the wood was recovered, dried at 60° C. in a thermostat for 3 days, and then the weight of the wood was measured. The decreasing ratio of the weight was calculated. For a reference, a piece of Japanese black pine wood treated with only 0.3 ml of acetone was tested and the decreasing ratio of the weight was calculated in the same manner.

The results are given below.

TABLE 1

| | The decreasing ratio |
|---|---|
| | of the weight (%) |
| 10 mg of octyl gallate | 2.4 |
| 100 mg of octyl gallate | 0.9 |
| Reference | 5.9 |

### Test Example 2

An acetone solution (1 ml) containing 10 mg of the test compound was dropped on filter paper (33 mm in diameter, Milk sediment disk 1026 produced by Toyo Roshi K.K.) and dried at room temperature overnight. The filter paper was set in a white plastic cup (35 mm in diameter) having one hole on side and one hole in bottom, wherein the diameter of the holes are about 3 mm and termites can easily go through the holes.

The white plastic cup was put into the 200 ml-volume plastic cup having several holes on the bottom which was covered with gypsum in 2 cm thickness. Fifty termites (Coptotermes formosanus, workers) were put in the 200 ml-volume plastic cup and kept in the container, the bottom of which was filled with wet cotton wool. The container was covered for keeping wet therein.

After one week, the filter paper was recovered, dried well at room temperature, and then the weight was measured. The decreasing ratio of the weight was calculated. The tests were repeated three times. For a reference, filter paper treated with only 1 ml of acetone was tested and the decreasing ratio of the weight was calculated in the same manner.

The results are given below.

TABLE 2

| | The decreasing ratio |
|---|---|
| Test compound | of the weight (%) |
| Decyl gallate | 0 |
| Dodecyl gallate | 1.13 |
| Reference | 7.63 |

We claim:

1. A method for preventing insects from feeding wooden material, which comprises applying an effective amount of a C8-C12 alkyl ester of gallic acid to wooden material.

2. The method according to claim 1, wherein the C8-C12 alkyl ester of gallic acid is octyl gallate, nonyl gallate, decyl gallate, undecyl gallate or dodecyl gallate.

3. The method according to claim 1, wherein the C8-C12 alkyl ester of gallic acid is octyl gallate, decyl gallate or dodecyl gallate.

4. The method according to claim 1, wherein the C8-C12 alkyl ester of gallic acid is octyl gallate.

5. The method according to claim 1, wherein the C8-C12 alkyl ester of gallic acid is decyl gallate.

6. The method according to claim 1, wherein the C8-C12 alkyl ester of gallic acid is dodecyl gallate.

7. The method according to any of claims 1-6, wherein the dosage of the C8-C12 alkyl ester of gallic acid is 0.01 to 100 g/m².
